(19) United States
(12) Patent Application Publication
(10) Pub. No.: US 2010/0266796 A1
(43) Pub. Date: Oct. 21, 2010

(54) Pneumatic Structural Element, and Roof Produced Therefrom

(76) Inventor: Mauro Pedretti, Biasca (CH)

Correspondence Address: WINSTEAD PC, P.O. BOX 50784, DALLAS, TX, 75201, US

(21) Appl. No.: 12/086,908

(22) PCT Filed: Dec. 22, 2006
(86) PCT No.: PCT/CH2006/000731

§ 371 Date: Aug. 20, 2008

(30) Foreign Application Priority Data
Dec. 23, 2005 (CH) 2073/05

(51) Int. Cl. B32B 1/06

(52) U.S. Cl. 428/36.1; 428/34.1; 428/36.6

(57) ABSTRACT

The pneumatic structural element according to the invention comprises from one to a number of interconnected elements of the following construction: two hollow bodies (1) made of textile material preferably coated in a gas-type manner and each having two end caps (5) are assembled such that they produce a common sectional area (2). The edging of this sectional area (2) is formed by two curved tension/compression elements (3) into which is clamped a preferably gas-tight web (4) made of a flexible material of high tensile strength. This web (4) can be connected to the tension/compression elements (3) in a gas-tight manner. By filling the two hollow bodies (1) with compressed gas, a tensile stress σ is built up in their casings (9) and is transmitted directly or via the tension/compression elements (3) to the web (4) and pretensions said web. This pretensioning greatly increases the bending rigidity of the tension/compression elements (3). If a plurality of such elements are combined to form a roof, every two adjacent hollow bodies (1) thus form a sectional area (2) with a tension/compression element (3) and web (4).

The present invention relates to a pneumatic structural element according to the preamble of claim 1.

Beam-like pneumatic structural elements and also those having a surface formation have become increasingly known over the last few years. These are mostly attributed to EP 01 903 559 (D1). A further development of said invention is provided in WO 2005/007991 (D2). Here, the compression rod has been further developed into a pair of curved compression rods which can also absorb tensile forces and are therefore designated as tension/compression elements. These run along respectively one surface line of the cigar-shaped pneumatic hollow body. D2 is considered to be the nearest prior art.

The strong elevated bending rigidity of the tension/compression elements loaded with compressive forces is based on the fact that a compression rod used according to D2 can be considered as an elastically bedded rod over its entire length, wherein such a rod is bedded on virtual distributed elasticities each having the spring hardness k.

The spring hardness k is there defined by

k=π·p

where
k=virtual spring hardness [N/m²]
p=pressure in hollow body [N/m²]
   with the result that the bending load Fₖ is obtained as

Fₖ=2\sqrt{k·E·I}[N]

where
E=modulus of elasticity [N/m²]
I=areal moment of inertia [m⁴]

The object of the present invention is to provide a pneumatic structural element having tension/compression elements and an elongated gas-tight hollow body which can be formed and expanded into both curved and/or surface structures, having a substantially increased bending load Fₖ compared with the pneumatic supports and structural elements known from the prior art.

The solution of the formulated object is reproduced with regard to its main features in the characterising part of claim 1, with regard to further advantageous features in the following claims.

The subject matter of the invention is explained in detail with reference to the appended drawings. In the figures:

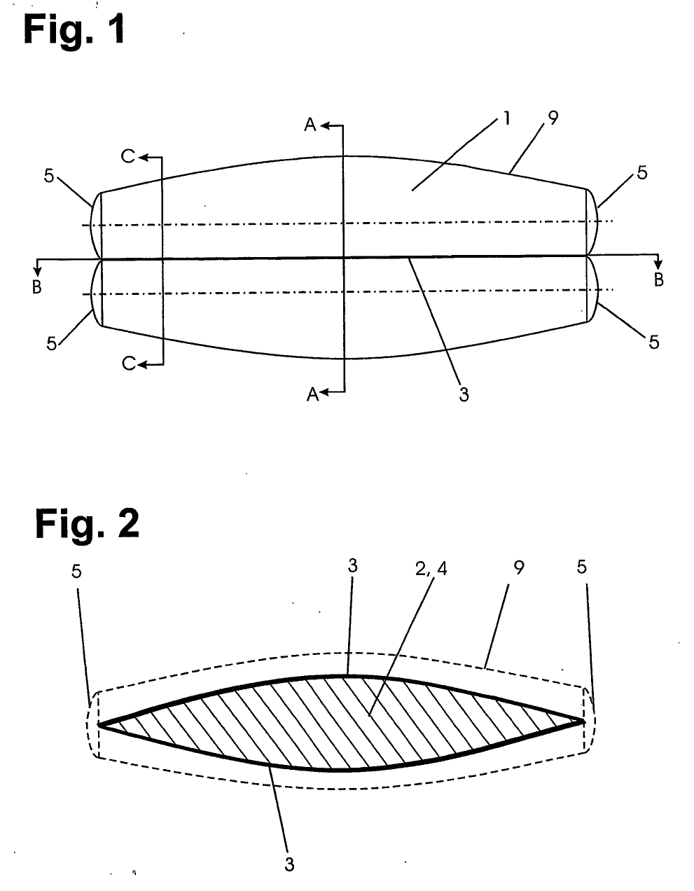

FIG. 1 shows a first exemplary embodiment of a pneumatic structural element according to the invention in plan view,

FIG. 2 shows the exemplary embodiment of FIG. 1 in longitudinal section BB,

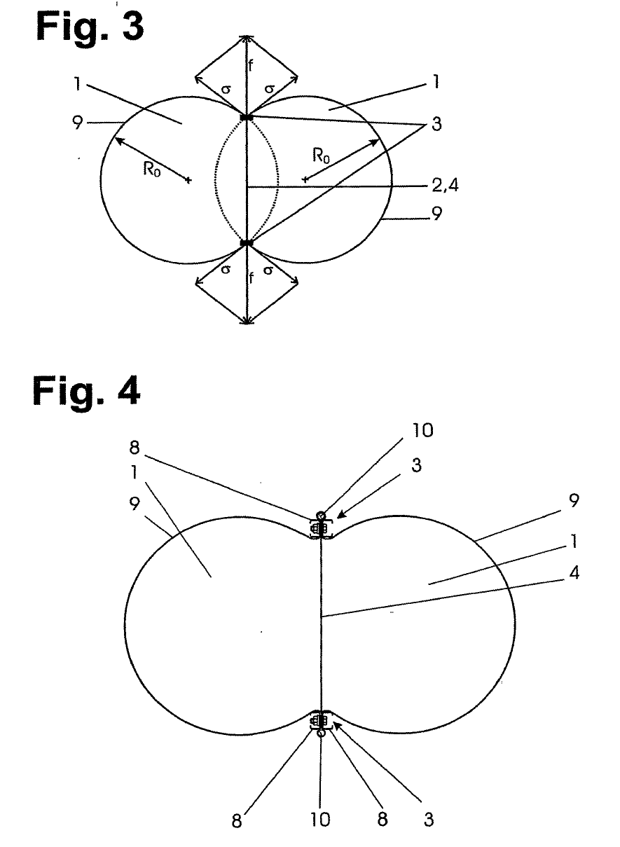

FIG. 3 shows a cross-section AA through the exemplary embodiment of FIG. 1 with the acting forces,

FIG. 4 shows the cross-section AA with an exemplary embodiment of a tension/compression element,

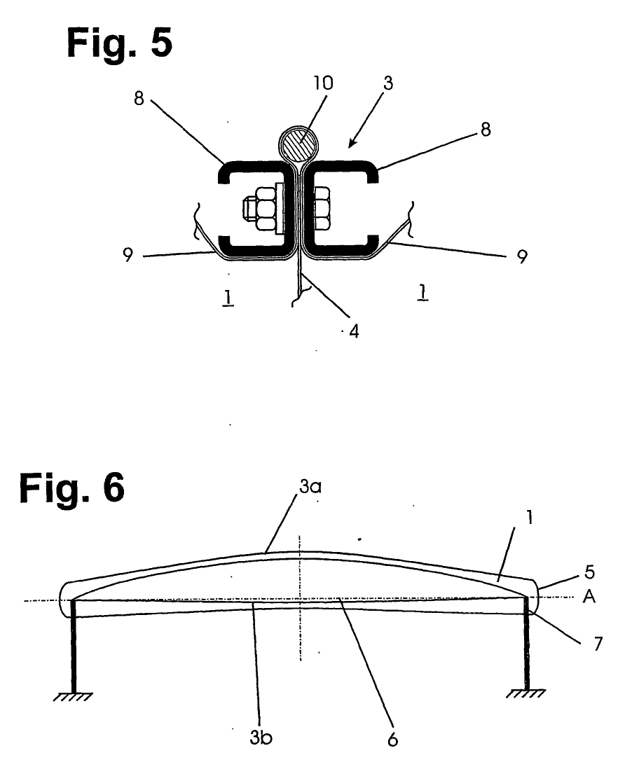

FIG. 5 shows a cross-section through a first exemplary embodiment of a tension/compression element in detail,

FIG. 6 shows a second exemplary embodiment of a pneumatic structural element in side view,

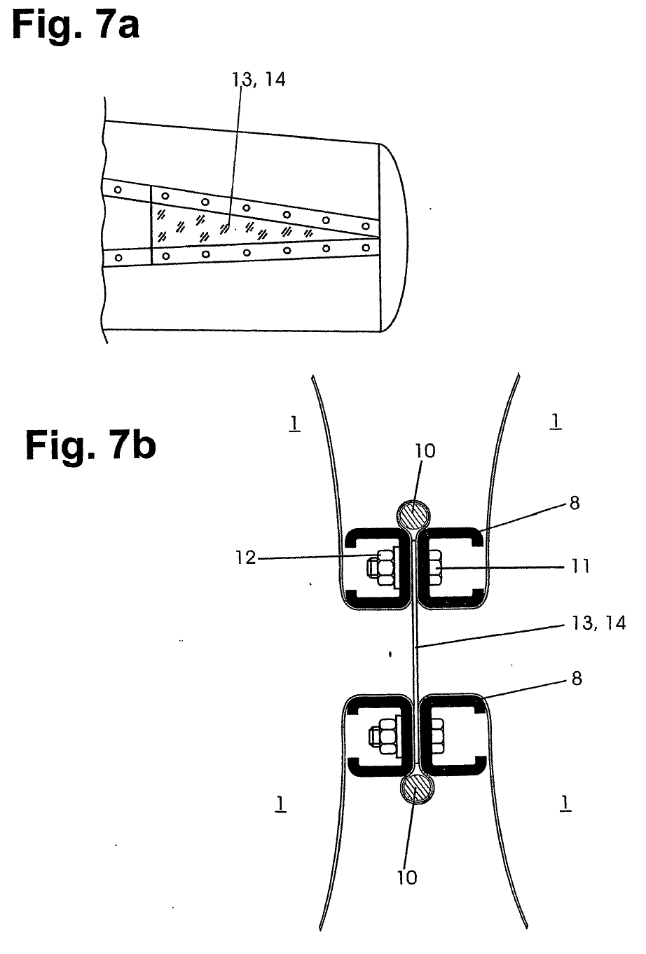

FIGS. 7a, b shows the region of one end of a pneumatic structural element according to FIG. 6,

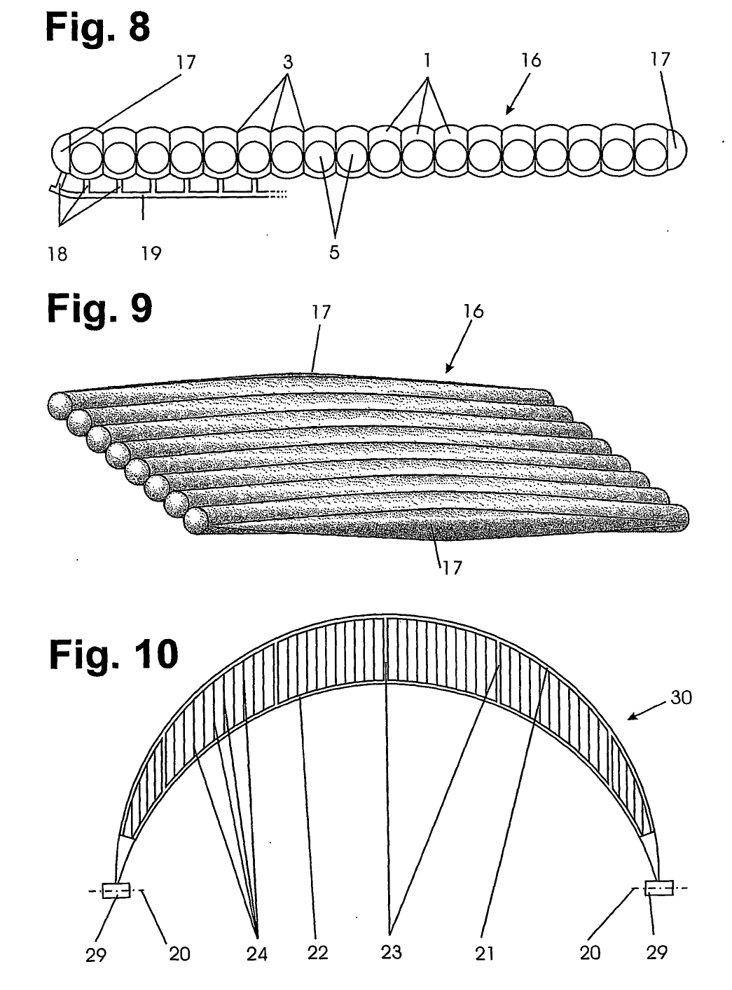

FIG. 8 shows a cross-section through a roof element according to the invention,

FIG. 9 shows a roof element according to FIG. 8 in isometric projection,

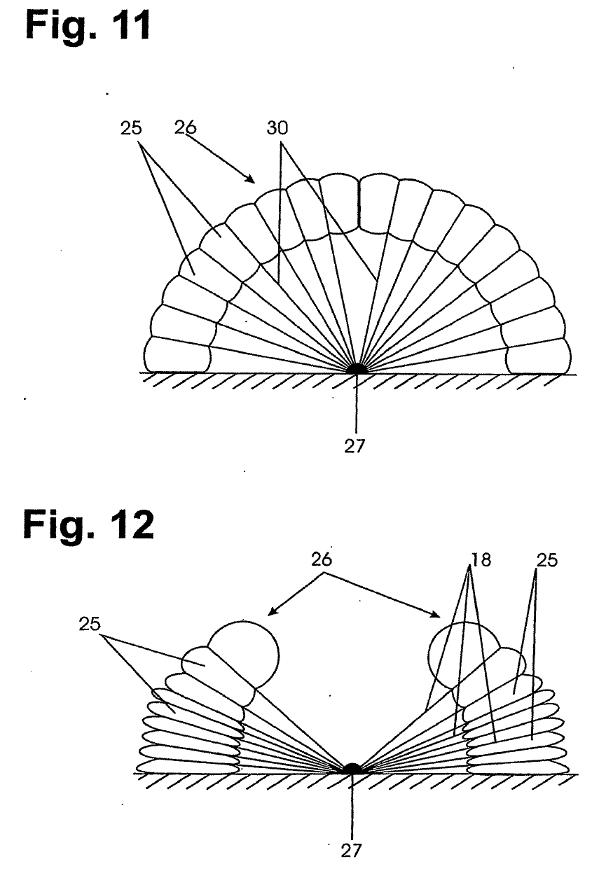

FIGS. 10, 11, 12 show an exemplary embodiment of the invention as elements of a domed roof.

FIG. 1 shows the pneumatic structural element according to the invention in a first exemplary embodiment in plan view. It is formed from two elongated, for example, cigar-shaped gas-tight hollow bodies 1 comprising a casing 9 and respectively two end caps 5. The casing 9 in each case consists of a textile-laminated plastic film or of flexible plastic-coated fabric. These hollow bodies 1 intersect one another, abstractly geometrically, in a sectional area 2 as can be seen from FIG. 2, which forms a section BB through FIG. 1.

When the two hollow bodies 1 are filled with compressed gas, they acquire the form shown in section AA of FIG. 4, under the conditions described hereinafter. As a result of the pressure p in the interior of the hollow body 1, a linear stress σ is built up in its casings 9, which is given by

σ=p·R
σ=linear stress [N/m]
p=pressure [N/m²]
R=radius of the hollow body 1 [m]

A textile web 4, for example, is inserted in the lines of intersection of the two hollow bodies 1, in the sectional area 2, to which the linear stresses σ of the two hollow bodies 1 are transmitted in the line of intersection, as shown in FIG. 3. FIG. 3 shows the vectorial addition of the linear stresses a to the linear force f in the web 4:

\vec{f}=\vec{σ}ₗ+\vec{σ}ᵣ

where
\vec{f}=linear force in the web 4
\vec{σ}ₗ=linear stress in the left hollow body 1
\vec{σ}ᵣ=linear stress in the right hollow body 1

For the same pressure p and the same radius R, the absolute magnitude of \vec{f} is dependent on the angle of intersection of the two circles of intersection of the two hollow bodies 1.

In order to absorb tensile and compressive forces of the pneumatic structural element which have thus built up, the web 4 is clamped into a tension/compression element 3 having the form shown in FIG. 2. The tension/compression element 3 absorbs the part of this linear force determined by the vector addition, as shown above, and is thereby pre-tensioned in the direction given by the vector representation. By filling the hollow body 1 with compressed air, a pre-tensioning of the web 4 by the linear force \vec{f} is obtained as f=2 σ sin φ. Since the radius along the structural element is not generally constant, the pre-tensioning of the web along the structural element varies. By a suitable choice of the casing circumference and web height, the pre-tensioning of the web can be optimised according to the use of the pneumatic structural element or even made constant. The pre-tensioning of the web 4 is then p·R₀, where 2R₀=diameter of the end caps 5.

This pre-tensioning brings about a behaviour of the tension/compression element 3 similar to a pre-tensioned string which only responds with a change in length when the pre-tensioning force is exceeded. Only when this pre-tensioning force is exceeded is there a risk of the tension/compression element 3 being bent. As a result of the indicated type of elastic bedding of the tension/compression element 3, the bending load Pₖ is given by

$${P}_{k} \approx 3 \frac{ {( EF )}^{2 / 9} \cdot {( EI )}^{1 / 3 }}{{L}^{2 / 9}} \cdot {( p \cdot {R}_{0} )}^{4 / 9}$$

where
Pₖ=critical bending load
E=modulus of elasticity of the tension/compression element 3
F=cross-sectional area of the tension/compression element 3
I=areal moment of inertia of the tension/compression element 3
   and
L=length of the tension/compression element 3.

In the pneumatic structural element according to the invention, therefore, the compressed air is used for pre-tensioning the flexible web so that this can transmit tensile and compressive forces and optimally stabilise the compression member against bending. The pneumatic structural element thus becomes more stable and light and is better able to bear local loads.

The tension/compression element 3 is laterally stabilised by the linear stresses σ in the casing 9.

FIG. 4 shows a technical embodiment of the diagram according to FIG. 3 in the section AA according to FIG. 1. The tension/compression element 3 in this case, for example, consists of two C profiles 8 which have been screwed together. The casing 9 of the hollow body 1 is, for example, pulled between the C profiles 8 without interruption and is secured externally on the tension/compression element 3 by means of a beading 10. The web 4 is inserted between the external layers of the casing 9 and is clamped securely by the screw connection of the C profiles 8.

FIG. 5 shows a section through the tension/compression element 3 thus executed in detail.

FIG. 6 shows a side view of a second exemplary embodiment of a pneumatic structural element according to the present invention. Compared to that of FIGS. 1 and 2, this is upwardly arched, its longitudinal axis, designated here with numeral 6, therefore now lying closer to the lower tension/compression element 3 designated as 3b than to the upper tension/compression element designated as 3a. The forces are derived via two supports 7 which absorb both vertical compressive and also tensile forces.

The ratio of length to height of the pneumatic structural elements shown in FIG. 4 is about 15.

FIGS. 7a, b show diagrams of one end of a pneumatic structural element according to the invention, for example, from FIG. 6; the end not shown is preferably executed mirror-symmetrically. At the ends of the tension/compression element 3, the two tension/compression elements are brought together and there form a node 14. This is produced by replacing the web 4, for example, by a plate 13 which transmits the necessary forces from and to the tension/compression elements 3. Depending on the tension/compression elements used however, such a solution can be differently configured for transmitting forces. These are accessible to the person skilled in the art without particular expense.

FIG. 7a shows a side view of the node 14 and FIG. 7b shows a cross-section.

FIG. 8 shows the front view of a roof element 16 composed of a plurality of structural elements according to FIG. 1. In each case, these are assembled at a tension/compression element 3 located between the hollow bodies 1. The spacing of the tension/compression elements 3 is in each case 2·R₀, the diameter of the end caps 5. A roof element 16 according to FIG. 7 can be placed on a suitable supporting structure. As long as the supporting surface is substantially flat, the type of support is non-critical: it is not necessary to place the roof element 16 on the tension/compression elements 3; it can also be placed on the hollow body 1 as long as there is no risk of injury. In order to erect a roof consisting of one or more roof elements 16, such a roof element 16 is joined together, in an assembly hall for example, from tension/compression elements 3, the webs 4 and the casings 9 of the hollow body 1. Each hollow body 1, with a gas-tight web 4, has its own connection 18 for the compressed gas. These connections 18 are usually placed on a common compressed gas line 19 so that all the hollow bodies 1 have the same gas pressure.

After assembling these said individual parts, the entire roof element 16 can be transported to the building site, on a lorry for example, and placed under gas pressure there. The roof element that is now stabilised by the compressed gas is placed on the provided and prepared support by means of a crane and secured there.

Lateral terminations 17 are located at the lateral ends of a roof element 16. These also consist of hollow bodies 1 as shown in FIG. 8. Their maximum diameter substantially corresponds to the lateral spacing of respectively two tension/compression elements 3. The form profile of the lateral terminations 17 can be seen from FIG. 8.

For large roofs a plurality of identical roof elements 16 can be placed adjacent to one another and in each case secured to one another at the outermost tension/compression elements 3.

FIGS. 10, 11 and 12 show a third exemplary embodiment of a pneumatic structural element according to the invention. FIG. 10 shows a curved tension/compression element 30 which rests on two pivot bearings 29 on a pivot axis 20 and is pivotable about said axis. The curved tension/compression element 30 comprises an outer arc 21 and an inner arc 22. These arcs 21, 22 are connected by a number, for example five, of struts 23 which are parallel to one another and by a plurality of tension wires 24 and are thus pre-stabilised without pneumatic hollow bodies. Again, as in the exemplary embodiment of FIGS. 1, 2, a web 4 is inserted parallel to the family of tension wires 24 and is secured to the arcs 21, 22 by means of a beaded connection.

FIG. 10 shows a dome-shaped roof 26 erected on curved pneumatic structural elements 25. Similarly to the first exemplary embodiment according to FIGS. 1 and 2, a number, for example eighteen, of hollow bodies 1 is produced and connected to the curved tension/compression elements 30 as shown. As executed for the roof element 16, the roof 26 can be prefabricated in an assembly hall. On the building site, a node 27 must be secured or concreted in the ground. At their ends, the curved tension/compression elements 30 each have a connection, not shown, which allows the curved tension/compression elements 30 to be pivotally mounted about the axes 20. Numerous solutions are known for this in construction engineering. After being transported to the building site, said connections are made at the node 27.

The dome-shaped roof 26 is now erected by filling the individual curved structural elements 25 with compressed gas. Since all the connections 18, as implemented in FIG. 7, are connected to a common compressed gas line 19, the uppermost structural element 25 will initially assume the round shape, successively followed by those located thereunder. The roof 26 is divided into two halves, which seal the roof tightly when completely filled.

Alternatively, the termination can be made by two curved tension/compression elements 30 which can be closed together, instead of by hollow bodies 1. For this purpose, a plurality of pneumatically or electrically actuated closure mechanisms (not shown) are distributed on said tension/compression elements 30. Numerous solutions are known for this in mechanical engineering.

1. A pneumatic structural element comprising at least two elongated hollow bodies (1) consisting of a gas-tight casing (9) of flexible material and at least two curved tension/compression elements (3) which are connected to one another at both ends in a node (14) and are connected to the casing (9) in a gas-tight manner substantially over their entire length, characterised in that
a web (4) of high-tensile-strength material is disposed in each case between two tension/compression elements (3) connected to one another at the node (14) and is connected to the two tension/compression elements (3) in a tensile manner over substantially their entire length, in such a manner that when the hollow bodies (1) are filled with compressed gas, the stress of the casings is transmitted to the tension/compression elements (3) and from these to the web (4) and thus pre-tensions said web.

2. The pneumatic structural element according to claim 1, characterised in that the web (4) consists of a flexible gas-tight material and is secured in a gas-tight manner on the tension/compression elements (3) and also terminates the adjacent hollow bodies (1) in a gas-tight manner towards one another.

3. The pneumatic structural element according to claim 2, characterised in that the gas-tight flexible material is a plastic film.

4. The pneumatic structural element according to claim 2, characterised in that the gas-tight flexible material is a plastic-coated textile material.

5. The pneumatic structural element according to claim 1 or 2, characterised in that
each tension/compression element (3) is constructed of two C profiles which are screwed to one another,
for each tension/compression element (3) there is provided a bead (10) comprising material of the casing (9) and which is disposed on the outside of the tension/compression element (3),
the web (4) is firmly clamped between the two C profiles of each tension/compression element (3) by the screw connection.

6. The pneumatic structural element according to claim 1 or 2, characterised in that
each tension/compression element (3) consists of a profile rod having three grooves for each beading (10), wherein two grooves for beading (10) are disposed laterally and a third groove for a beading (10) is disposed centrally,
the casing (9) is firmly clamped by the lateral beading (10) and the web (4) is firmly clamped by the centrally disposed beading (10).

7. The pneumatic structural element according to claim 1 or 2, characterised in that
each tension/compression element (3) consists of a profile rod having a suitable areal moment of inertia,
each profile rod is inserted in a pocket (11) running longitudinally to the tension/compression element (3),
the casing (9) of the hollow body (1) is connected to this pocket (11) in a gas-tight manner,
the web (4) is likewise connected to this pocket (11),
the connections of casings (9) and web (4) to the pocket (11) are produced by welding or adhesive bonding or sewing with subsequent sealing.

8. The pneumatic structural element according to claim 7, characterised in that the connection of the pocket (11) to the web (4) is made in a gas-tight manner.

9. The pneumatic structural element according to claim 1, characterised in that
means are provided for guiding the tension/compression element (3) in a gas-tight manner out from the hollow bodies (1),
the nodes (14) are disposed outside the hollow body (1).

10. The pneumatic structural element according to claim 1 or 2, characterised in that
it is implemented as a roof element (16, 26),
a plurality of tension/compression elements (3) is provided at this roof element (16, 26),
in each case a hollow body (1) is inserted between two adjacent pairs of tension/compression elements (3) and connected to said elements in a gas-tight manner,
each hollow body (1) of the roof element (16, 26) has a connection (18) for compressed gas.

11. The pneumatic structural element according to claim 10, characterised in that
said plurality of tension/compression elements (3) are arranged substantially parallel to one another,
the two outermost tension/compression elements (3) each bear an unpaired hollow body (1) whereby the pre-tensioning of the web (4) is symmetrical and the outermost tension/compression elements (3) are laterally stabilised.

12. The pneumatic structural element according to claim 10, characterised in that
said plurality of tension/compression elements (3) is configured as curved as a curved tension/compression element (30) each having an outer arc (21) and an inner arc (22) which are each connected by a node (14) and are connected by a first plurality of struts (23) which are parallel to one another and another plurality of tension wires (24) which are likewise parallel to one another and to the struts (23), whereby the curved tension/compression element (30) is pre-stabilised without hollow bodies (1),
a gas-tight web (4) is inserted in each case between the arcs (21, 22) and is connected in a gas-tight manner to the curved tension/compression elements (30),
respectively one hollow body (1) is inserted between the curved tension/compression elements (30) and is connected to said tension/compression elements (30) in a gas-tight manner,
each of the curved tension/compression elements (30) has a connection at its node (14), with which it can be connected in an articulated manner to a further node (27) fixed to the ground,
the further node (27) fixed to the ground each has an axis (20) on which the curved tension/compression elements (30) are pivotally mounted,
the pneumatic structural elements thus designed are formed in two groups of substantially the same size,
said plurality of curved tension/compression elements (30) is dimensioned such that after all the hollow bodies (1) have been filled with compressed gas, said pneumatic structural elements can form a closed domed roof,
the hollow bodies (1) each have at least one connection (18) for compressed gas.

13. The pneumatic structural element according to claim 10 and 12, characterised in that the connections (18) for compressed gas are situated on a common compressed gas line (19) so that all the hollow bodies (1) have the same gas pressure.

14. The pneumatic structural element according to claim 12, characterised in that the two outermost curved tension/compression elements (30) in each group each bear an unpaired hollow body (1), whereby the pre-tensioning of the web (4) is symmetrical and said outermost movable curved tension/compression elements (30) are laterally stabilised.

15. The pneumatic structural element according to claim 12, characterised in that
the two outermost movable curved tension/compression elements (30) of each group are terminated by their webs (4),
said movable curved tension/compression elements (30) each bear at least one closure mechanism which can lock the two said movable curved tension/compression elements (30) with one another.
